(19) United States
(12) Patent Application Publication
(10) Pub. No.: US 2015/0138828 A1
(43) Pub. Date: May 21, 2015

(54) BACKLIGHT SOURCE AND DISPLAY DEVICE

(71) Applicants: XIAMEN TIANMA MICRO-ELECTRONICS CO., LTD., Xiamen (CN); TIANMA MICRO-ELECTRONICS CO., LTD., Shenzhen (CN)

(72) Inventor: Yaozuo KE, Xiamen (CN)

(73) Assignees: XIAMEN TIANMA MICRO-ELECTRONICS CO., LTD., Xiamen (CN); TIANMA MICRO-ELECTRONICS CO., LTD., Shenzhen (CN)

(21) Appl. No.: 14/271,462

(22) Filed: May 7, 2014

(30) Foreign Application Priority Data
Nov. 15, 2013 (CN) 201310578972.4

(51) Int. Cl. F21V 8/00

(52) U.S. Cl. CPC G02B 6/0088; G02B 6/005
USPC 362/606; 362/615; 362/617

(57) ABSTRACT

Embodiments of the invention provide a backlight source and a display device. An aperture is formed in a frame of the backlight source. A light guide plate in the backlight source is provided with a flank. The flank extends outwards through the aperture. The display device includes the backlight source, and a light transmitting region for transmitting light from the flank of the light guide plate is arranged on the side wall of the display device. The light emission of the side wall of the display device is realized, the application range of the backlight source is widened and the light emitting diversity is increased on the condition of not adding other light sources.

### RELATED APPLICATION INFORMATION

This application claims priority to Chinese Patent Application No. 201310578972.4, entitled “BACKLIGHT SOURCES AND DISPLAY DEVICES”, filed with the State Intellectual Property Office of People's Republic of China on Nov. 15, 2013, the content of which is incorporated herein by reference in its entirety for all purposes.

### BACKGROUND OF THE INVENTION

The present invention relates to the field of display technologies. More specifically, embodiments of the present invention are directed to backlight sources and display devices. Backlighting is an important aspect of modern display devices.

Side edges of a display device, such as a mobile phone, in the prior art are basically surrounded by an enclosure made of a plastic or metallic material, and since such functional keys as volume key, USB interface, mobile phone on-off key are arranged on the enclosure, the appearance is quite monotonous.

Most existing display devices such as mobile phones adopt liquid crystal display (LCD) screens, the LCD screens do not emit light, and as a result the required light source is provided by a backlight source. A light emitting source in the existing mobile phone backlight source includes a light emitting diode (LED) that is installed on the side face of the backlight source, and a light guide plate in the backlight source may change the point light source of the LED into a surface light source. To prevent light leakage on the side edge of the backlight source, the light guide plate is generally surrounded by a side edge frame of the backlight source through a plastic frame or an iron frame, and as a result, the backlight source is only aimed for providing a light source to an LCD panel.

### BRIEF DESCRIPTION OF THE DRAWINGS

FIG. 1 is a simplified schematic diagram of a structure of a light guide plate provided with a flank in a backlight source according to an embodiment of the present invention;

FIG. 2 is a simplified schematic diagram of a structure of a light guide plate provided with a flank in another backlight source according to an embodiment of the present invention;

FIG. 3 is a simplified schematic diagram of a structure of a light guide plate provided with a flank in another backlight source according to an embodiment of the present invention;

FIG. 4 is a simplified schematic diagram of a structure of a display device according to an embodiment of the present invention;

FIG. 5(a) and FIG. 5(b) are simplified schematic diagrams of a structure of a display device containing a light guide film according to an embodiment of the present invention;

FIG. 6(a) and FIG. 6(b) are simplified schematic diagrams of a structure of a display device containing a shade according to an embodiment of the present invention.

### DETAILED DESCRIPTION

Embodiments of the invention provide a backlight source and a display device, which are used for realizing side wall light emission of the display device, broadening applications of the backlight source, and increasing the light emitting diversity without adding additional light sources.

Detailed description is given below on the technical solution provided by the embodiments of the invention.

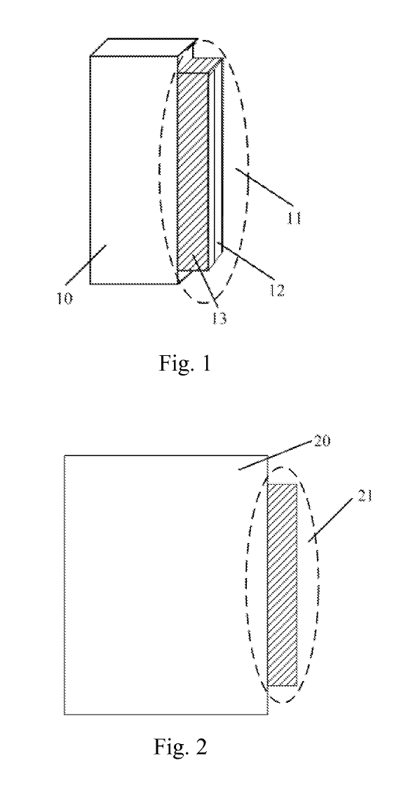

As illustrated in FIG. 1, a backlight source in an embodiment of the invention includes a frame and a light guide plate 10 arranged in the frame. The light guide plate 10 includes a flank 11. The frame of the backlight source includes an aperture at a corresponding position, which allows the flank 11 of the light guide plate 10 to extend outwards through the aperture. The frame of the backlight source in FIG. 1 is provided with two apertures, both of which are arranged on the long edge of the frame of the backlight source. The dimension of the aperture may be set according to practical applications, and the aperture may extend to the entirety of long edge of the frame to the maximum. In addition, the flank 11 of the light guide plate includes a first region 12 and a second region 13, wherein the first region 12 is a light emitting region of the light guide plate, and the second region 13 is a non-light emitting region of the light guide plate. The flank of the light guide plate may emit light by guiding the light from the backlight source. In actual implementations, the entirety of the flank of the light guide plate is not necessarily used as the light emitting region (i.e., the first region). To optimize light utilization, the flank region that is not configured for light emission (i.e., the second region) is shaded by a shade. Therefore, the flank of the light guide plate is divided into the light emitting region and the non-light emitting region, which are beneficial for reasonable utilization of the light in practical application.

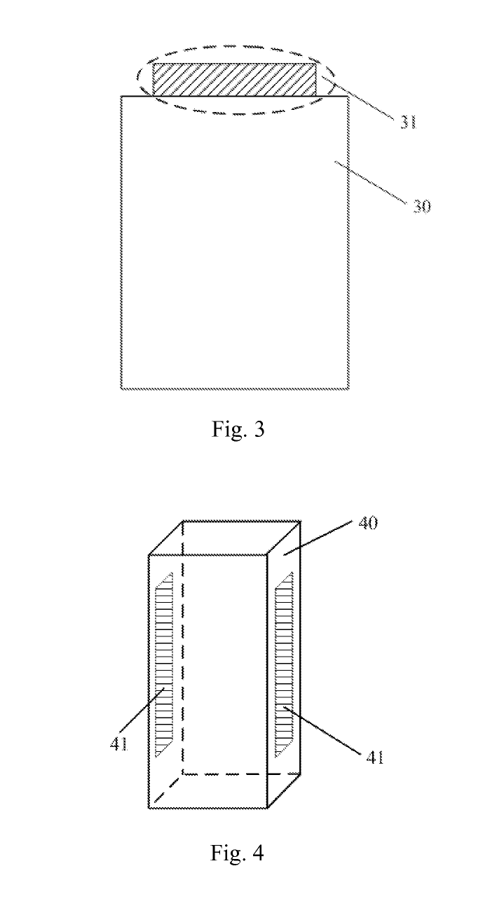

As illustrated in FIG. 2, which is a front view of the backlight source, one aperture is formed in the frame of the backlight source so that the flank 21 of the light guide plate 20 extends outwards through the aperture. The aperture is located on the long edge of the frame of the backlight source, and the aperture may at most extend to the entire long edge of the frame according to practical applications. As illustrated in FIG. 3, which is a front view of the backlight source, one aperture is formed in the frame of the backlight source so that the flank 31 of the light guide plate 30 extends outwards through the aperture. The aperture is located on the short edge of the frame of the backlight source, and may at most extend to the entire short edge of the frame according to practical applications.

It should be noted that the number of the apertures formed in the frame of the backlight source may be set according to practical applications without being limited to one or two apertures provided by the embodiments of the invention. More than two apertures may also be formed on the long or short edge at one side of the frame of the backlight source, the light guide plate is correspondingly provided with more than two flanks, and the flanks of the light guide plate extends outwards through the apertures. Therefore, when two apertures are formed in the frame of the backlight source and located on the long edge of the frame of the backlight source, the backlight source symmetrically emits light through the flanks of the light guide plate so as to provide a better visual effect to the user.

As illustrated in FIG. 4, an embodiment of the invention further provides a display device containing the above backlight source. The display device can be a mobile phone, a flat panel, a computer or a television, and the like. If the display device is a mobile phone, a light transmitting region 41 for transmitting light from the flank of the light guide plate is arranged at the enclosure 40 on the side wall of the mobile phone, where the light transmitting region comprises a transparent material. Specifically, the transparent material can be light-permeable material(s) as polycarbonate (PC) material or glass material.

Preferably, the flank of the light guide plate includes a first region and a second region. The first region serves as a light emitting region for providing a light source to the light transmitting region of the side wall of the display device. The second region serves as a non-light emitting region covered by a shade to avoid providing a light source to the light transmitting region of the side wall of the display device. The dimensions of the light transmitting region of the side wall of the display device do not necessarily match that of the first region of the flank of the light guide plate. Light transmitting regions with different dimensions may be arranged according to specific implementations.

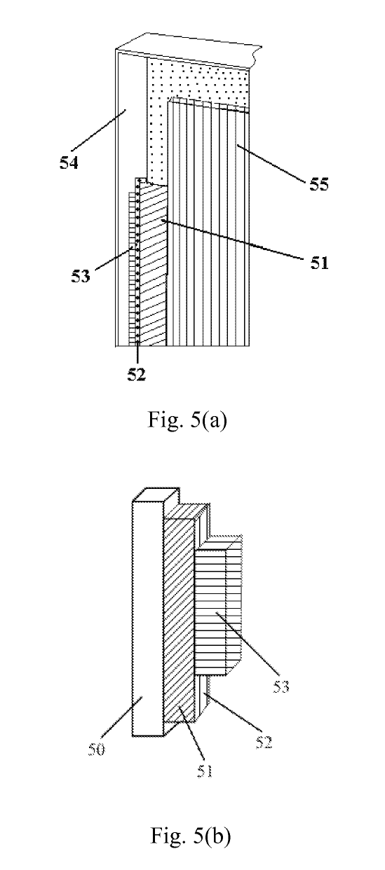

As illustrated in FIG. 5(a) and FIG. 5(b), taking a mobile phone as an example of the display device in an embodiment of the invention. The reference number 54 refers to the enclosure of the mobile phone. The reference number 55 refers to the backlight source of the mobile phone. The display device is further provided with a light guide film 52 for converting white light of the backlight source into colored light. A user can match various colors with the enclosure of the display device, where the light guide film 52 may be adhered on the first region of the flank 51 of the light guide plate 50 between the first region and the light transmitting region 53 of the side wall of the display device. The light guide film 52 can also be adhered on the light transmitting region 53 of the side wall of the display device between the first region of the flank 51 of the light guide plate and the light transmitting region 53 of the side wall of the display device. The light guide film 52 can be arranged between the first region of the flank 51 of the light guide plate 50 and the light transmitting region 53 of the side wall of the display device through other manners. FIG. 5(a) and FIG. 5(b) merely illustrate that the light guide film 52 is adhered on the first region of the flank 51 of the light guide plate 50 between the first region and the light transmitting region 53 of the side wall of the display device.

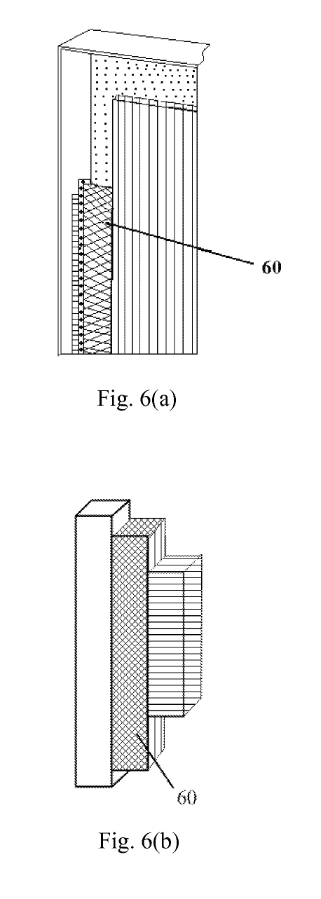

As illustrated in FIG. 6(a) and FIG. 6(b), in order to prevent light leakage and increase the utilization rate of light, a shade 60 is covered on the second region, namely, the non-light emitting region of the flank of the light guide plate, and only the first region, namely, the light emitting region of the flank of the light guide plate can emit light, wherein the shade 60 is a black and white shading tape, and the shade may be coated in a coating and brushing manner.

It is to be appreciated that embodiments of the present invention can be implemented in different ways. For example, embodiments of the invention provide a backlight source and a display device.

According to an embodiment of the invention, a backlight source includes a frame and a light guide plate arranged in the frame, an aperture is formed in the frame of the backlight source, the light guide plate is provided with a flank, and the flank extends outwards through the aperture.

According to the backlight source provided by the embodiment of the invention, the light guide plate in the backlight source is provided with the flank, so that light in the backlight source can be led out to increase the application range of the backlight source and increase the light emitting diversity.

Preferably, the flank of the light guide plate includes a first region and a second region, wherein the first region is a light emitting region of the light guide plate, and the second region is a non-light emitting region of the light guide plate.

Preferably, at least one aperture is formed in the frame of the backlight source, and the aperture is located on the long edge and/or short edge of the frame of the backlight source.

Preferably, two apertures are formed in the frame of the backlight source, and the apertures are located on the long edge of the frame of the backlight source.

An embodiment of the invention further provides a display device, the display device includes the above backlight source, and a light transmitting region used for transmitting light from the flank of the light guide plate is arranged on the side wall of the display device.

According to the display device provided by the embodiment of the invention, the light transmitting region used for transmitting the light from the flank of the light guide plate is arranged on the side wall of the display device, so that the arrangement at the side wall of the display device is more colorful.

Preferably, the light transmitting region is made of a transparent material.

Therefore, the transparent material can better transmit the light from the flank of the light guide plate.

Preferably, the transparent material is a PC material or a glass material.

In this way, the PC material or the glass material is used as the transparent material, thus it is more convenient to obtain the raw material of the transparent material in actual production.

Preferably, the flank of the light guide plate includes a first region and a second region, the first region serves as a light emitting region for providing a light source to the light transmitting region of the side wall of the display device, and the second region serves as a non-light emitting region covered by a shade to avoid providing the light source to the light transmitting region of the side wall of the display device.

Therefore, the non-light emitting region covered by the shade is used for better utilizing the light emitted from the flank of the light guide plate and avoiding light leakage.

Preferably, the display device is further provided with a light guide film, and the light guide film is located between the first region of the flank of the light guide plate and the light transmitting region of the side wall of the display device.

In this way, since the light guide film has various colors, the light guide film arranged between the first region of the flank of the light guide plate and the light transmitting region of the side wall of the display device can convert white light of the backlight source into necessary light with various colors for users.

Preferably, the light guide film is located on the first region of the flank of the light guide plate between the first region and the light transmitting region of the side wall of the display device; or the light guide film is located on the light transmitting region of the side wall of the display device between the first region of the flank of the light guide plate and the light transmitting region of the side wall of the display device.

In this way, the light guide film is more convenient and simpler to be arranged on the first region or on the light transmitting region of the side wall of the display device.

Preferably, the shade covered on the second region is a black and white shading tape.

In this way, the black and white shading tape is used as the shade of the second region and is easy to be obtained in actual production, and the price is low.

Preferably, the display device is a mobile phone, a flat panel, a computer or a television.

In this way, the display device is the mobile phone, the flat panel, the computer or the television. Since the mobile phone, the flat panel, the computer and the television are display devices more frequently used by users, the display device according to the embodiment of the invention can have a wider application prospect.

Evidently those skilled in the art can make various modifications and variations to the embodiments of the invention without departing from the spirit and scope of the embodiments of the invention and claims thereof. Thus the invention is also intended to encompass these modifications and variations thereto so long as the modifications and variations come into the scope of the claims appended to the invention and their equivalents.

What is claimed is:

1. A backlight source comprising:
a frame; and
a light guide plate arranged in the frame;
wherein an aperture is positioned in the frame;
the light guide plate is provided with a flank, and the flank extends outwards through the aperture.

2. The backlight source of claim 1, wherein the flank of the light guide plate comprises a first region and a second region, the first region is a light emitting region of the light guide plate, and the second region is a non-light emitting region of the light guide plate.

3. The backlight source of claim 2, wherein at least one aperture is formed in the frame of the backlight source, and the aperture is located on a long edge and/or short edge of the frame of the backlight source.

4. The backlight source of claim 3, wherein two apertures are formed in the frame of the backlight source, and the apertures are both located on the long edge of the frame of the backlight source.

5. A display device, comprising the backlight source of any of claims 1, wherein a light transmitting region for transmitting light from the flank of the light guide plate is arranged on a side wall of the display device.

6. The display device of claim 5, wherein the light transmitting region is made of a transparent material.

7. The display device of claim 6, wherein the transparent material is a PC material or a glass material.

8. The display device of claim 5, wherein the flank of the light guide plate comprises a first region and a second region, the first region serves as a light emitting region for providing a light source to the light transmitting region of the side wall of the display device, and the second region served as a non-light emitting region is covered by a shade to avoid providing a light source to the light transmitting region of the side wall of the display device.

9. The display device of claim 8, wherein the display device is further provided with a light guide film, and the light guide film is located between the first region of the flank of the light guide plate and the light transmitting region of the side wall of the display device.

10. The display device of claim 9, wherein the light guide film is located on the first region of the flank of the light guide plate between the first region and the light transmitting region of the side wall of the display device; or the light guide film is located on the light transmitting region of the side wall of the display device between the first region of the flank of the light guide plate and the light transmitting region of the side wall of the display device.

11. The display device of claim 8, wherein the shade covered on the second region is a black and white shading tape.

12. The display device of any of claims 5, wherein the display device is a mobile phone, a flat panel, a computer or a television.
